(19) United States
(12) Patent Application Publication
(10) Pub. No.: US 2006/0036779 A1
(43) Pub. Date: Feb. 16, 2006

(54) Method and control system for controlling a plurality of function blocks

(75) Inventors: Kyeong-man Kim, Suwon-si (KR); Goo-soo Gahang, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/201,114

(22) Filed: Aug. 11, 2005

(30) Foreign Application Priority Data
Aug. 16, 2004 (KR) 10-2004-0064308

(51) Int. Cl. G06F 13/12

(52) U.S. Cl. 710/8

(57) ABSTRACT

Provided is a control system for controlling a plurality of function blocks. The control system includes a plurality of function blocks each including at least one function register; a central processing unit outputting a setting command to set a function register value of at least one of the plurality of function blocks; a setting controller receiving the setting command from the central processing unit to set the at least one function register of at least one of the plurality of function blocks to predetermined setting data according to the setting command; a memory storing the predetermined setting data of the at least one function register; and a bus supporting a data interchanging operation among the central processing unit, the memory, and the setting controller.

### CROSS-REFERENCE TO RELATED APPLICATION

This application claims the benefit of Korean Patent Application No. 2004-64308 filed on Aug. 16, 2004 in the Korean Intellectual Property Office, the disclosure of which is incorporated herein by reference.

### BACKGROUND OF THE INVENTION

1. Field of the Invention

The present invention relates generally to a control system using a bus. More particularly, the present invention relates to a control system for setting function registers of each of a plurality of function blocks using a setting controller.

2. Description of the Related Art

With the development of electronic technology, electronic devices having various functions have been developed. In detail, up-to-date image forming apparatuses support various functions such as a Joint Photographic Experts Group (JPEG) compression function, a network communication function, and the like.

Such an electronic device includes a plurality of function blocks each performing various functions, and a central processing unit (CPU) controlling the whole electronic device. The CPU controls each of the plurality of function blocks using a bus so that the plurality of function blocks performs their functions.

FIG. 1 is a view illustrating a conventional control system of an electronic device using a bus. Referring to FIG. 1, the conventional control system includes a CPU 10, a memory 20, a bus 30, and function blocks 41, 42, . . . , and k. Each of the function blocks 41, 42, . . . , and k includes function registers (FRs).

In order to allow each of the function blocks 41, 42, . . . , and k of the control system to perform a specific operation, the FRs in the each of the function blocks 41, 42, . . . , and k must be set to predetermined data so as to be suitable in an operation mode.

In one of the conventional methods of setting FRs, the CPU 10 directly sets the FRs in each of the function blocks 41, 42, . . . , and k one by one at a time. Thus, as shown in FIG. 1, for a second function block F2, n FR data must be set. Thus, as the number of FRs increases, efficiency of the CPU 10 deteriorates. Also, the bus 30 must be used whenever the FRs are set, and thus the bus 30 cannot be efficiently used.

As another conventional method of setting FRs, function blocks directly reading FR data from the memory 20 and automatically setting the FR data may be used. In other words, when the CPU 10 transmits a register setting command to each of the function blocks 41, 42, . . . and k, each of the function blocks 41, 42, . . . , and k directly reads FR data from a predetermined position of the memory 20 and automatically sets the FR data. To realize such a method, each of the function blocks 41, 42, . . . , and k must have a direct memory access (DMA) function of directly reading data from the memory 20 and functions of determining whether the read data is data for setting FRs and automatically setting the FRs depending on the read data. However, since most of currently used function blocks do not have these functions, they are not compatible with existing function blocks. Also, when the function blocks having these functions are used, manufacturing cost for the whole control system is increased.

### SUMMARY OF THE INVENTION

Additional aspects and/or advantages of the invention will be set forth in part in the description which follows and, in part, will be apparent from the description, or may be learned by practice of the invention.

Accordingly, the present general inventive concept has been made to solve the above-mentioned and/or problems, and an aspect of the present general inventive concept is to provide a control system including a setting controller setting FRs so as to improve efficiency of a CPU.

Another aspect of the present general inventive concept is to provide a control system including an additional bus control setting so as to improve bus utilization.

According to an aspect of the present invention, there is provided a control system including a plurality of function blocks each including at least one function register; a central processing unit outputting a setting command to set a function register value of each of the plurality of function blocks; and a setting controller receiving the setting command from the central processing unit to set the at least one function register of each of the plurality of function blocks to predetermined setting data according to the setting command.

The control system may further include a memory storing the predetermined setting data of the at least one function register; and a first bus supporting a data interchange operation among the central processing unit, the memory, and the setting controller.

The setting controller may include a command set buffer storing a command set including an address of the at least one function register and the predetermined setting data.

The setting command may include at least one or more of ID information of the setting controller, mode information designating an operation mode of the setting controller, index information designating a predetermined command set in the command set buffer, length information of the command set, and address information of an area of the memory from which the command set is to be loaded.

The mode information may select one of a loading mode in which a command set is read from a memory area designated by the address information and stored in the command set buffer, an executing mode in which the function register is set according to the command set stored in the command set buffer, a loading and executing mode in which the command set is loaded and set, and a clear mode in which a predetermined command set designated by the index information in the command set buffer is deleted.

When the mode information in the setting command sets the executing mode, the setting controller may set a function register of a predetermined function block based on a command set designated by the index information.

The control system may further include a second bus interfacing the setting controller with each of the plurality of function blocks so that the setting controller transmits the predetermined setting data to each of the plurality of function blocks and sets the predetermined setting data. Here, the control system may further include a bus interface interfacing the first bus with the second bus.

The control system may further include: a setting control bus interfacing the setting controller to each of the plurality of function blocks so that the setting controller transmits the predetermined setting data to each of the plurality of function blocks and sets the predetermined setting data; a bus interface interfacing with the first bus; and a second bus interfacing each of the plurality of function block with the bus interface.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates the structure of a conventional control system;

FIG. 2 illustrates the structure of a control system according to an embodiment of the present invention;

FIG. 3 illustrates the structure of a setting command a CPU transmits to a setting controller in the control system shown in FIG. 2;

FIG. 4 illustrates the structure of a command set (CS) buffer inside the setting controller;

FIG. 5 illustrates the structure of a control system according to another embodiment of the present invention;

FIG. 6 illustrates the structure of a control system according to still another embodiment of the present invention; and

FIG. 7 is a flowchart of a method of setting FRs according to an embodiment of the present invention.

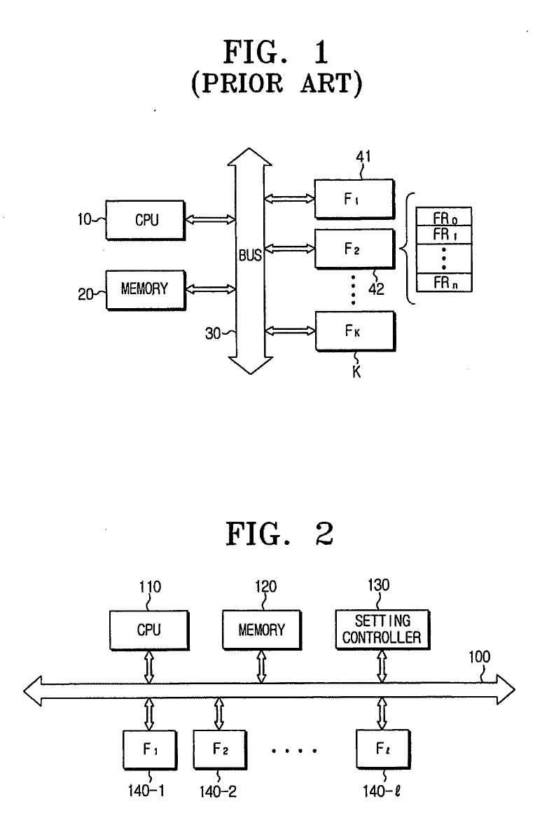

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Certain embodiments of the present invention will be described in greater detail with reference to the accompanying drawings.

In the following description, the same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

FIG. 2 is a view illustrating the structure of a control system according to an embodiment of the present invention. Referring to FIG. 2, the control system includes a bus 100, a CPU 110, a memory 120, a setting controller 130, and a plurality of function blocks 140-1, 140-2, . . . , and 140-I.

The bus 100 serves as a data transmission passageway among components of the control system. The CPU 110 controls the whole control system and transmits a setting command to set FRs of each of the function blocks 140-1, 140-2, . . . , and 140-I through the bus 100 to the setting controller 130.

The setting controller 130 identifies the received setting command to load a CS from the memory 120 or set the FRs of each of the function blocks 140-1, 140-2, . . . , and 140-I based upon a pre-loaded CS. The setting controller 130 includes a CS buffer to store the CS loaded from the memory 120 in the CS buffer. The CS includes FR addresses and FR data corresponding to the FR addresses. Thus, when the setting controller 130 receives the setting command to set the FRs based upon the CS stored in the CS buffer from the CPU 110, the setting controller 130 sets the FRs of each of the function blocks 140-1, 140-2, . . . , and 140-I respectively.

The setting controller 130 may control function blocks of the function blocks 140-1, 140-2, . . . , and 140-I having a DMA function and an FR automatically setting function to directly extract FR data from the memory 120 so as to set the FR data.

Each of the function blocks 140-1, 140-2, . . . , and 140-I performs specific functions such as a network communication function, a JPEG compression function, and the like, using the FRs set to predetermined data.

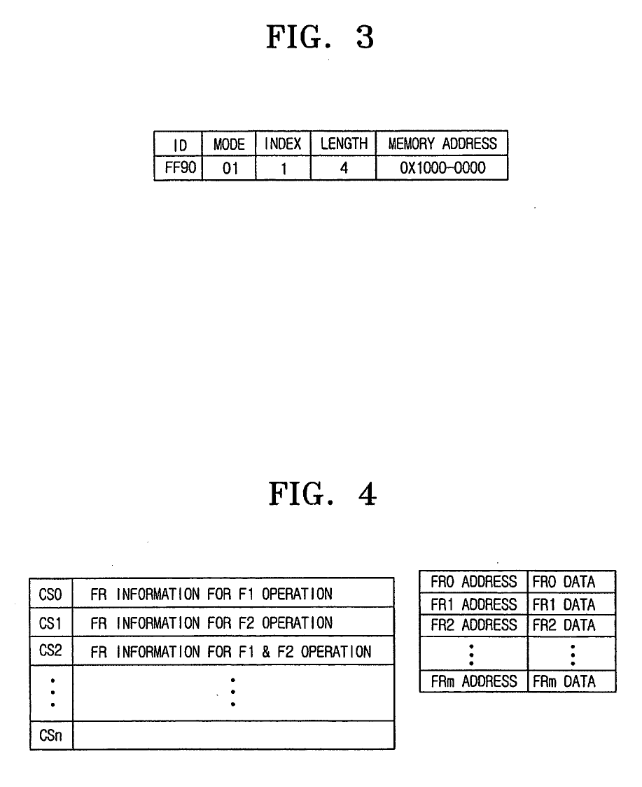

FIG. 3 is a view illustrating the structure of the setting command transmitted from the CPU 110 to the setting controller 130. Referring to FIG. 3, the setting command includes an ID, mode information, an index, a data length, and a memory address. The ID is to designate the setting controller 130. If the ID of the setting command is equal to an ID of the setting controller 130, for example, FF90 shown in FIG. 3, the setting controller 130 receives the ID of the setting command.

The mode information is to designate a mode of the setting controller 130 and may be expressed as “00,” “01,” “10,” and “11” that are 2-bit signals. The mode information “00” may indicate a loading mode in which data is read from the memory 120 and stored in the CS buffer of the setting controller 130, the mode information “01” may indicate an executing mode in which the FRs are set according to the CS stored in the CS buffer, the mode information “10” may indicate a loading and executing mode in which data is stored and simultaneously the FR are set, and the mode information “11” may indicate a clear mode in which the FR data stored in the CS buffer is deleted.

The index is an index number designating an address of each CS buffer. The FR data is recorded or set depending on the type of a designated mode of a CS designated by the index.

The data length designates the length of one CS in the CS buffer, and the memory address designates a memory area from which data to be recorded in the CS buffer is to be extracted. Only when the mode information is “00” or “10”, that is, only when data is loaded into the CS buffer, the memory address is used.

FIG. 4 is a view illustrating the structure of the CS buffer inside the setting controller 130 and the structure of one CS recorded in the CS buffer. The CS buffer stores CSs for setting FRs of each of function blocks, each of the CSs being identified by the index. When the setting controller 130 receives the setting command set to the executing mode, that is, the mode information “01” or “10,” from the CPU 140, the setting controller 130 identifies the index to select a specific CS. In this case, since each of the CSs includes a plurality of FR addresses and FR data corresponding to the FR addresses, the setting controller 130 checks a data length to select the length of a CS to be executed. Thus, the setting controller 130 transmits the FR addresses and the FR data of the selected CS to a corresponding function block to set FRs.

In a case where the setting command as shown in FIG. 3 is transmitted, the index is “1,” and thus CS1 is executed. The CS1 includes FR0 through FRm addresses and FR0 through FRm data of a second function block. Since the data length is “4,” FRs FR0 through FR3 of the second function block are set depending on the FR0 through FR3 data.

If the mode information of the setting command shown in FIG. 3 is “00,” the mode information indicates the loading mode. Thus, FR addresses and FR data are read from a designated memory address “0×1000_{—}0000” and recorded in a designated CS.

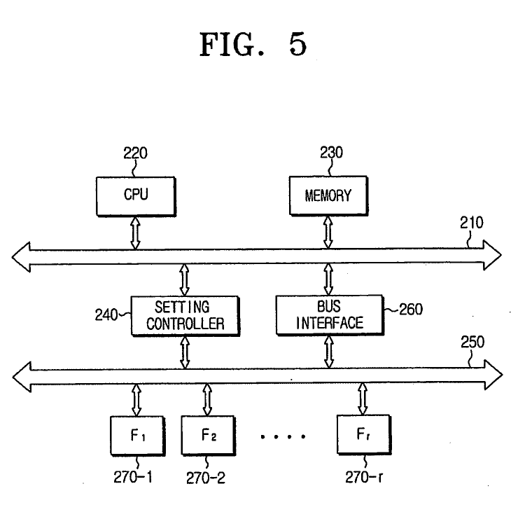

FIG. 5 is a view illustrating the structure of a control system according to another embodiment of the present invention. Referring to FIG. 5, the control system includes a first bus 210, a CPU 220, a memory 230, a setting controller 240, a second bus 250, a bus interface 260, and a plurality of function blocks 270-1, 270-2, . . . , 270-r.

The first bus 210 serves as a data transmission passageway among the CPU 220, the memory 230, and the setting controller 240. The CPU 220 transmits a setting command through the first bus 210 to the setting controller 240, and the setting controller 240 loads a CS through the first bus 210 from the memory 230 and stores the CS in a CS buffer. The first bus 210 interfaces with the second bus 250 via the bus interface 260.

The setting controller 240 sets FRs of each of the function blocks 270-1, 270-2, . . . , 270-r using the second bus 250. In other words, when the setting controller 240-receives the setting command to set a specific CS from the CPU 220, the setting controller 240 transmits FR addresses and FR data recorded in the CS buffer through the second bus 250 to a corresponding function block of the function blocks 270-1, 270-2, . . . , 270-r and sets the FRs. According to the present embodiment, the second bus 250 can be additionally provided to set the FRs so as to improve bus utilization. The setting command transmitted from the CPU 220 and the structure of the CS buffer are the same as those described above and thus will not be described herein.

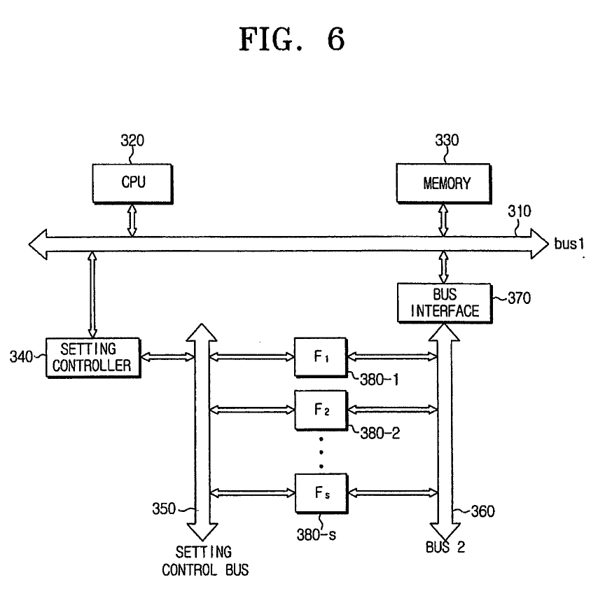

FIG. 6 is a view illustrating the structure of a control system according to still another embodiment of the present invention. Referring to FIG. 6, the control system includes a first bus 310, a CPU 320, a memory 330, a setting controller 340, a setting control bus 350, a second bus 360, a bus interface 370, and a plurality of function blocks 380-1, 380-2, . . . , 380-s.

The CPU 320 transmits a setting command having a structure as shown in FIG. 3 through the first bus 310 to the setting controller 340. Thus, the setting controller 340 loads a designated CS or performs a setting operation. In this case, the setting controller 340 transmits FR data to each of the function blocks 380-1, 380-2, . . . , 380-s using the setting control bus 350 to set FRs. The setting control bus 350 is an additional bus provided for the setting operation and for efficiently using the first bust 310.

The second bus 360 and the bus interface 370 may be further provided to interface each of the function blocks 380-1, 380-2, . . . , 380-s with the memory 330. Thus, a transmission delay in the first bus 310 can be prevented. In the present embodiment described with reference to FIG. 6, a function register is set according to the same method as those described in the previous embodiments except that the setting control bus 250 is further provided. Thus, a setting method will not be described in the present embodiment.

Buses used in the above-described embodiments may be Advanced Microcontroller Bus Architectures (AMBAs), Advanced High-performance Buses (AHBs), Peripheral Component Interconnects (PICs), or the like used in a general control system.

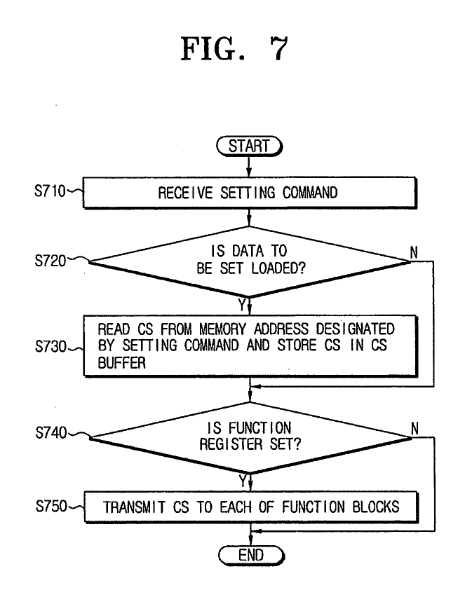

FIG. 7 is a flowchart of a method of setting each of function blocks using the setting controller 130, 240, or 340 according to an embodiment of the present invention. Referring to FIG. 7, in operation S710, the setting controller 130, 240, or 340 receives a setting command from the CPU 110, 120, or 320. In operation S720, the setting controller 130, 240, or 340 checks mode information in the setting command to determine whether to load a CS.

If the setting controller 130, 240, or 340 determines to load the CS, in operation S730, the setting controller 130, 240, or 340 performs a loading operation to read the CS from a memory address designated in the setting command and store the CS in a CS buffer according to a CS index designated in the setting command.

In operation S740, the setting controller 130, 240, or 340 determines whether mode information in the setting command indicates an executing mode. If the setting controller 130, 240, or 340 determines that the mode information indicates the executing mode, in operation S750, the setting controller 130, 240, or 340 transmits a CS designated by the CS index to each of the function blocks to set FRs. As described above, the setting controller 130, 240, or 340 assumes full charge of setting the FRs of each of the function blocks. Thus, an operation burden on the CPU 110, 220, or 320 can be lightened.

In a case where specific data is set in a special function register (SFR) secured for performing a specific function in each of function blocks, such a setting method can be used as it is.

As described above, in a control system for controlling a plurality of function blocks according to embodiments of the present invention, although all of the function blocks do not have a DMA function, a register automatically setting function, and the like, a setting controller can assume full charge of setting FRs of each of the function blocks. Thus, a CPU can be efficiently used. Also, a bus for setting the FRs can be additionally provided so as to improve bus utilization.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A control system, comprising:
a plurality of function blocks each having at least one function register;
a central processing unit outputting a setting command to set a function register value of at least one of the plurality of function blocks; and
a setting controller receiving the setting command from the central processing unit to set the at least one function register of the at least one of the plurality of function blocks to predetermined setting data based on the setting command.

2. The control system of claim 1, further comprising:
a memory storing the predetermined setting data of the at least one function register; and
a first bus supporting a data interchanging operation among the central processing unit, the memory, and the setting controller.

3. The control system of claim 2, wherein the setting controller comprises a command set buffer storing a command set including an address of the at least one function register and the predetermined setting data.

4. The control system of claim 3, wherein the setting command includes at least one or more of identification information of the setting controller, mode information designating an operation mode of the setting controller, index information designating a predetermined command set in the command set buffer, length information of the command set, and address information of an area of the memory from which the command set is to be loaded.

5. The control system of claim 4, wherein the mode information selects one of a loading mode in which a command set is read from a memory area designated by the address information and stored in the command set buffer, an executing mode in which the function register is set according to the command set stored in the command set buffer, a loading and executing mode in which the command set is loaded and set, and a clear mode in which a predetermined command set designated by the index information in the command set buffer is deleted.

6. The control system of claim 5, wherein, when the mode information in the setting command sets the executing mode, the setting controller sets a function register of a predetermined function block according to a command set designated by the index information.

7. The control system of claim 2, further comprising a second bus interfacing the setting controller with each of the plurality of function blocks so that the setting controller transmits the predetermined setting data to each of the plurality of function blocks and sets the predetermined setting data.

8. The control system of claim 7, further comprising a bus interface interfacing the first bus with the second bus.

9. The control system of claim 2, further comprising:
a setting control bus interfacing the setting controller to each of the plurality of function blocks so that the setting controller transmits the predetermined setting data to each of the plurality of function blocks and sets the predetermined setting data;
a bus interface interfacing with the first bus; and
a second bus interfacing each of the plurality of function block with the bus interface.

10. The control system of claim 1, wherein the setting controller sets a function register value in each of the plurality of function block.
